(19) United States
(12) Patent Application Publication
(10) Pub. No.: US 2010/0094689 A1
(43) Pub. Date: Apr. 15, 2010

(54) Method, System, and Graphical User Interface For Coupon or Advertisement Delivery

(76) Inventor: Nicholas Philippe Fodor, Belmont, CA (US)

Correspondence Address: MORGAN, LEWIS & BOCKIUS, LLP. (PA), 2 PALO ALTO SQUARE, 3000 EL CAMINO REAL, SUITE 700, PALO ALTO, CA, 94306, US

(21) Appl. No.: 12/252,317

(22) Filed: Oct. 15, 2008

(51) Int. Cl. G06Q 30/00; G06F 3/14

(52) U.S. Cl. 705/14.1; 715/864

(57) ABSTRACT

A method, system, and graphical user interface for delivering coupons when a user of a mobile communication device sends an electronic message and is waiting for an electronic message delivery confirmation is described. At a server, an electronic message is received from a mobile communication device. The server forwards the electronic message to a server associated with a recipient of the electronic message. The server causes concurrent display of an electronic message delivery progress message and a coupon at the mobile communication device. In response to receiving an acknowledgement from the server associated with the recipient of the electronic message that the electronic message has been stored for the recipient, the server causes display of a delivery completion message at the mobile communication device that the electronic message has been delivered.

### TECHNICAL FIELD

The disclosed embodiments relate generally to information delivery. More particularly, the disclosed embodiments relate to methods and systems for information delivery when a user of a mobile communication device sends an electronic message and is waiting for a delivery confirmation.

### BACKGROUND

When sending electronic messages (e.g., emails) from a mobile communication device, such as Smartphone, it can be important for the user to view a confirmation message that the electronic message has been sent. The time it takes for the user to receive the confirmation message is often wasted time.

### SUMMARY

The disclosed embodiments provide improved methods, systems and user interfaces for providing information, such as a coupon or other advertisement, on a waiting screen that is displayed when a user of a mobile communication device sends an electronic message and is waiting for a delivery confirmation.

### BRIEF DESCRIPTION OF THE DRAWINGS

For a better understanding of the aforementioned aspects of the invention as well as additional aspects and embodiments thereof, reference should be made to the Description of Embodiments below, in conjunction with the following drawings in which like reference numerals refer to corresponding parts throughout the figures.

FIG. 1 is a block diagram illustrating an exemplary distributed computer system.

FIGS. 2A-2B are flowcharts that illustrate providing coupons to a mobile communication device.

FIGS. 3A-3D illustrate graphical user interfaces for displaying a coupon on a mobile communication device.

FIG. 4 is a flowchart of a method for activating coupons at a mobile communication device.

FIGS. 5 is a flowchart of a method for selecting coupons for providing to a mobile communication device.

FIG. 6 is a block diagram illustrating a mobile communication device.

FIG. 7 is a block diagram illustrating an electronic messaging server.

### DESCRIPTION OF EMBODIMENTS

Methods, systems, and user interfaces for providing personalized information, such as a coupon, on a waiting screen that is displayed when a user of a mobile communication device sends an electronic message and is waiting for a delivery confirmation are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention as defined by the appended claims.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

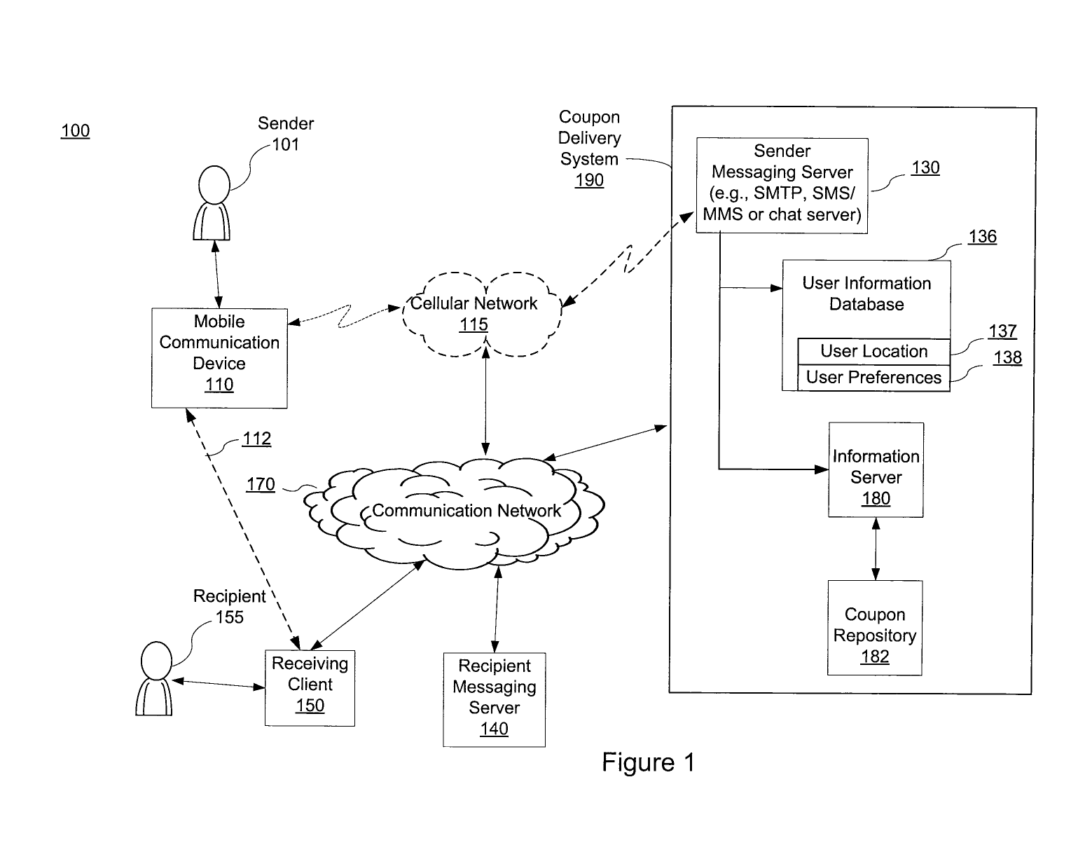

FIG. 1 is a block diagram illustrating a distributed computer system 100 according to one embodiment of the invention. FIG. 1 shows various functional components that will be referred to in the detailed discussion that follows. The system 100 may include a mobile communication device 110 that is used by a sender 101 to send one or more electronic messages (e.g., emails, SMS/MMSs, instant messages, etc.) to a receiving client 150 associated with a recipient 155. Mobile communication device 110 can be any of a number of devices (e.g., cellular telephone, personal digital assistant, etc.) capable of sending an electronic message. Receiving client 150 can be any of a number of devices (e.g., computer, internet kiosk, personal digital assistant, cellular telephone, gaming device, desktop computer, or laptop computer) capable of receiving an electronic message.

Mobile communication device 110 and receiving client 150 are connected to a communications network 170, which can be any of a number of networks (e.g. Internet, intranet, local area network, wide area network, wireless network, wired network, optical network, etc.). Also shown in FIG. 1 is a cellular network 115, which connects mobile communication device 110 to communications network 170, in the case where the mobile communication device 110 is a cellular telephone, PDA or other device capable of using such a communications network 170.

Associated with mobile communication device 110 is a coupon delivery system 190 in communication with communications network 170. Coupon delivery system 190 includes a sender messaging server 130 (e.g., connected to the cellular network 150), a user information database 136, an Information Server 180, and a coupon repository 182. In some embodiments, fewer and/or additional modules, functions or databases are included in the Coupon delivery system 190. In some embodiments, some or all of these modules, functions, or data bases may be combined dependent on the need sand capabilities of the communications network and the systems and/or devices being used therewith. The modules shown in FIG. 1 as being part of Coupon delivery system 190 represent functions performed in an embodiment.

Associated with receiving client 150 is a recipient messaging server 140. Sender messaging server 130 and recipient messaging server 140 are in communication with each other using communications network 170. In addition, dashed line 112 represents an embodiment in which the mobile communication device and receiving client 150 are in direct communication with each other, using appropriate protocols (e.g., XMPP/Jabber). In other embodiments, the mobile communication device 110 communicates directly with the recipient messaging server 140 using appropriate protocols. In yet other embodiments, the sender messaging server 130 communicates directly with the receiving client 150 using appropriate protocols.

According to some embodiments, when sender 101 uses an electronic messaging application, such an email application, at the mobile communication device 110, sender messaging server 130, which may be SMTP, LMTP, or ESMTP server, at coupon delivery system 190 forwards the electronic message to recipient's messaging server 140. Sender messaging server 130 causes display of a coupon or other advertisement simultaneous to the display of the delivery progress message in a waiting screen at the mobile communication device 110. The coupon or advertisement may be served from coupons stored on Information Server 180, stored in a cache at the sender messaging server 130, or stored in a cache on the mobile communication device 110. Depending on where the coupons are stored, they may served by the Information Server 180, sender messaging server 130 or mobile communication device 110.

In the embodiments described herein, Information Server 180 serves coupons or other advertisements for insertion into an electronic message delivery acknowledgement progress screen. Of course, instead of or in addition to coupons, Information Server 180 can also serve other items of information, such as advertisements, news, or any other information with or without the intention to sell something to a user.

In some embodiments, user information database 136 stores location information 137 for users, such as sender 101. In some embodiments, the location information may be obtained from the telephone area code associated with the mobile communication device 110, e.g., in the case it is a cellular telephone. In some embodiments, the location information may be obtained from location aware devices using GPS, cell tower location, Wi-fi location, and so on. In some embodiments, the coupon is specific to a location of the sender 101, which may be retrieved from user information database 136. But, this may not lead to the most accurate coupons as sender 101 may be outside the physical area specified by the telephone area code. Therefore, in some embodiments, location information stored in user information database 136 is obtained from information (e.g., zip code information) supplied by sender 101, for instance, when registering for (or creating a user profile for) the electronic message account used to send the electronic message. In other embodiments, location information may be obtained from location aware devices as needed.

In some embodiments, user information database 136 may also store other user information besides location information. For instance, user information database 136 may also store user preference information 138, such as what kind of coupons a sender 101 may like to receive or what kind of coupons a user has used (e.g., received, activated, or redeemed) before. For instance, a sender 101 may prefer coupons related to food, as opposed to those related to shopping for clothes. In some embodiments, user preference information is obtained from analyzing user activation of displayed coupons. For instance, if a user consistently (e.g., more than 50% of the time) activates coupons related to food, but does not activate coupons related to shopping, then it may be determined that the user has a preference for coupons related to food. This user preference information may be stored in the user information database 136.

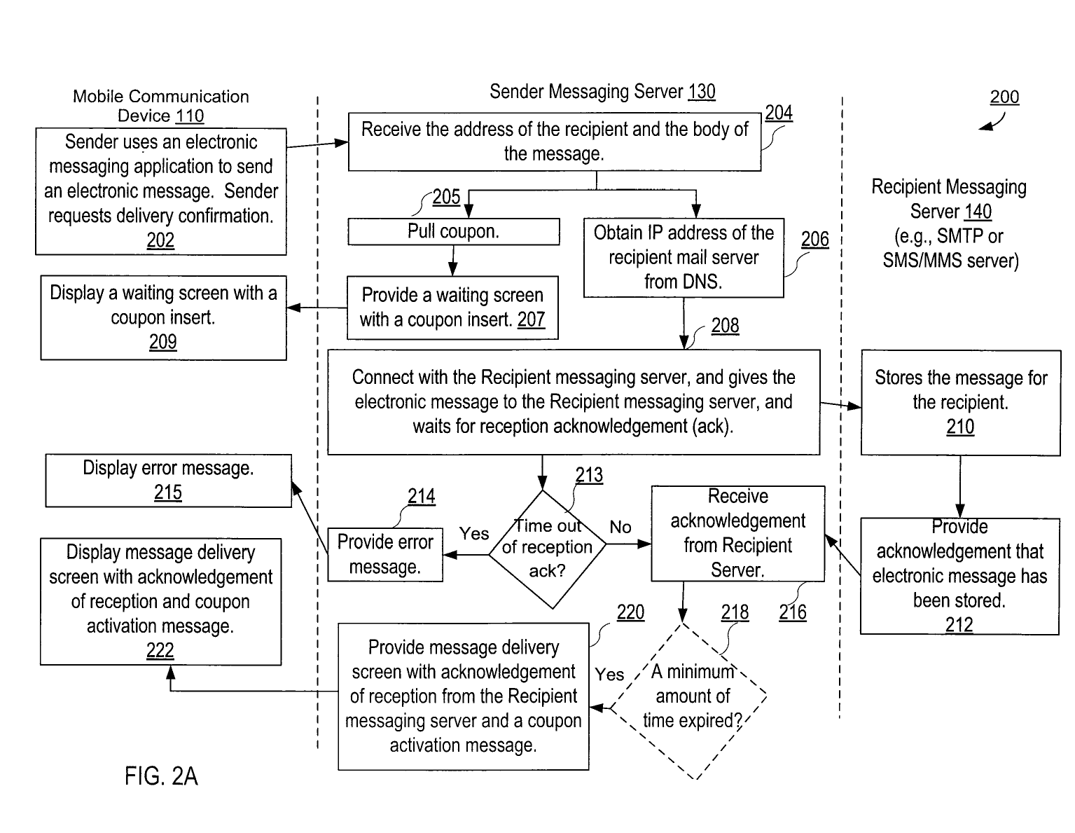

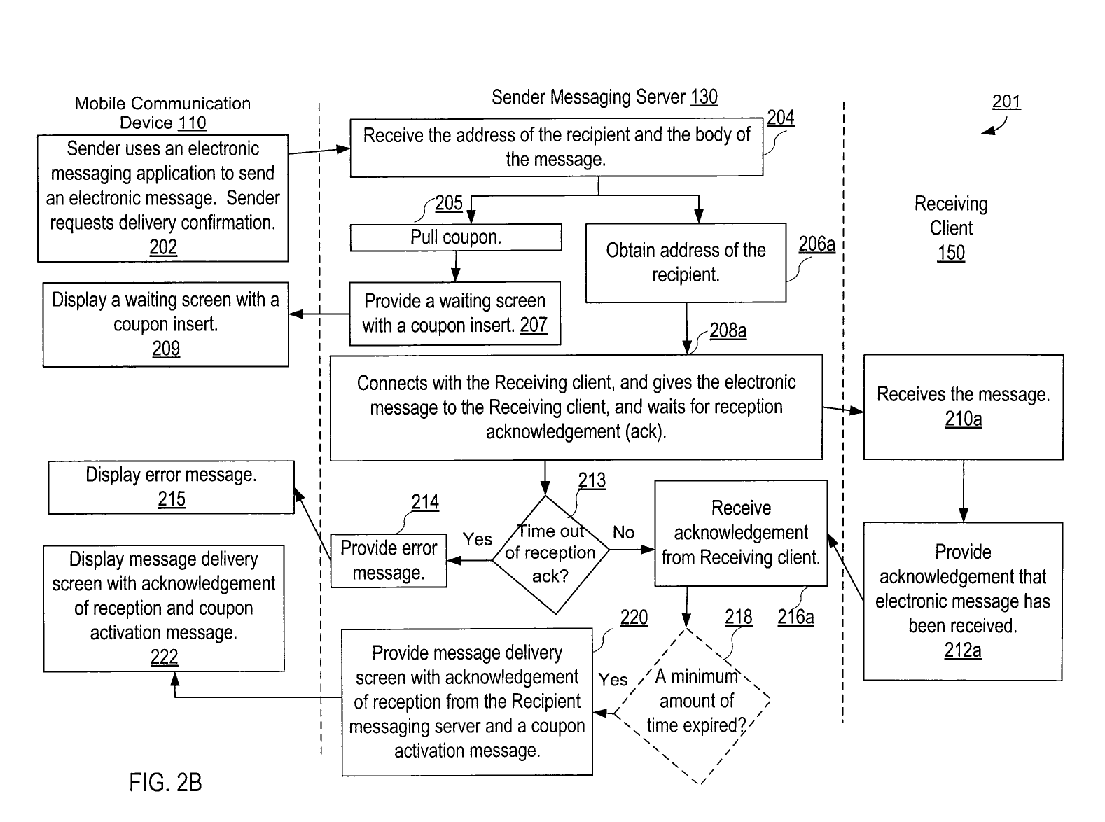

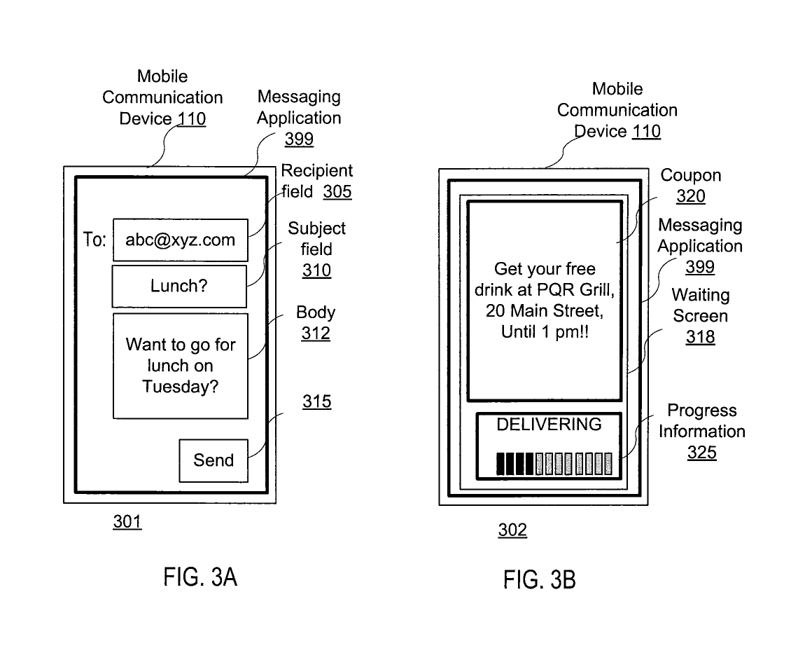

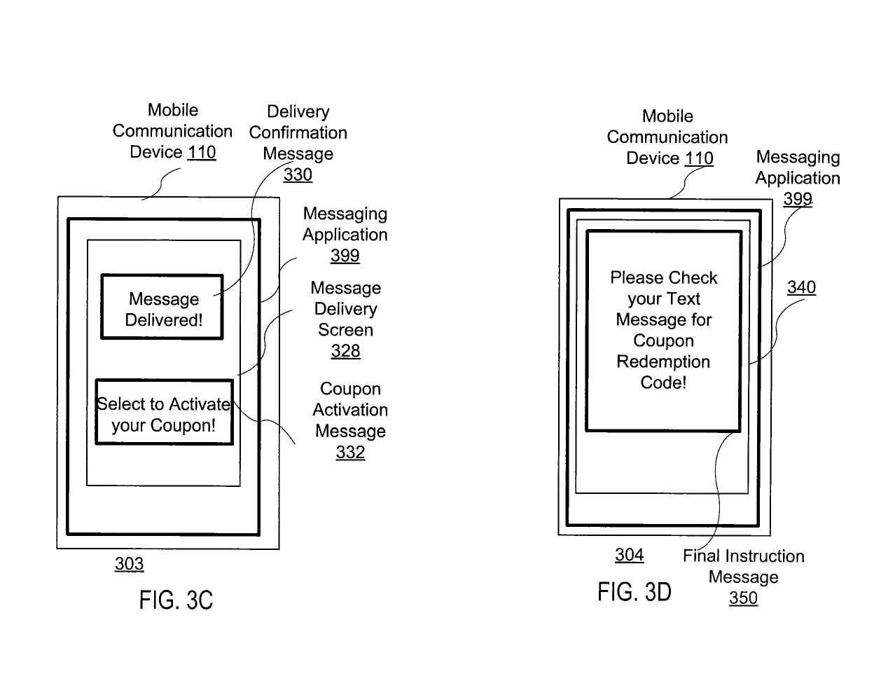

FIGS. 2A-2B illustrate flow charts of processes 200 and 201 respectively for displaying coupons at a mobile communication device 110. In the embodiments described in FIGS. 2A-2B, coupons are displayed to a user in a waiting screen that also displays delivery progress information for an electronic message, such as an email, MMS/SMS, or instant message. In other embodiments, coupons are displayed to a user after the user sends an electronic message, without displaying delivery progress information. FIGS. 3A-3D illustrates examples 300 of some of the graphical user interfaces (GUIs) at the mobile communication device 110.

At 202, sender 101 uses an electronic messaging application at mobile communication device 110 to send an electronic message to a recipient 155. FIG. 3A illustrates an example of a GUI 301 of a sender 101 using an electronic messaging application 399 at mobile communication device 110 to send an electronic message to a recipient 155. GUI 301 includes a recipient field 305, where the sender 101 enters the recipient's addressing information, such as an email address, e.g., abc@xyz.com or a phone number. GUI 301 includes a subject field 310, where the sender 101 may optionally enter the subject of the electronic message, e.g., “Lunch?”. GUI 301 includes an electronic message body 312, where the sender 101 may optionally enter the body of the electronic message, e.g., “Want to go for lunch on Tuesday?”. GUI 301 includes at least a “Send” button 315, which the sender 101 may use to send the electronic message. The “Send” button 315 may be part of the GUI 301, or may be an actual button (hard or soft) on the mobile communication device 110. Also, the sender 101 may be simply forwarding an electronic message to a recipient 155, and as such, may not actually author the subject and/or body of the electronic message.

In some embodiments, at 202, sender 101 explicitly requests a confirmation that the electronic message has been delivered to the receiving client 150. For instance, when sending an electronic text message via SMS, sender 101 may choose to request delivery reports (e.g, by adding *0# or *N# to the beginning of the text message). In other embodiments, sender 101 does not explicitly request delivery confirmation information.

Referring back to FIG. 2A, at 204, sender messaging server 130 receives the electronic message information, including header information including the address of the recipient (e.g., abc@xyz.com), and the body of the message (e.g., Lunch? “Want to go for lunch on Tuesday?”). At 206, sender messaging server 130 initiates the electronic message delivery process, for instance by obtaining an IP address of the recipient messaging server 140 from a domain name server (DNS server) in communication with the communications network 170.

In parallel to initiating the electronic message delivery process (at 206), at 205, sender messaging server 130 pulls a coupon for display at mobile communication device 110. In some embodiments, the coupon is pulled automatically, and not in response to an explicit request for a coupon by sender 101. In some embodiments, the coupon is pulled automatically in response to an electronic message delivery confirmation request by sender 101, and not in response to an explicit request for a coupon by sender 101.

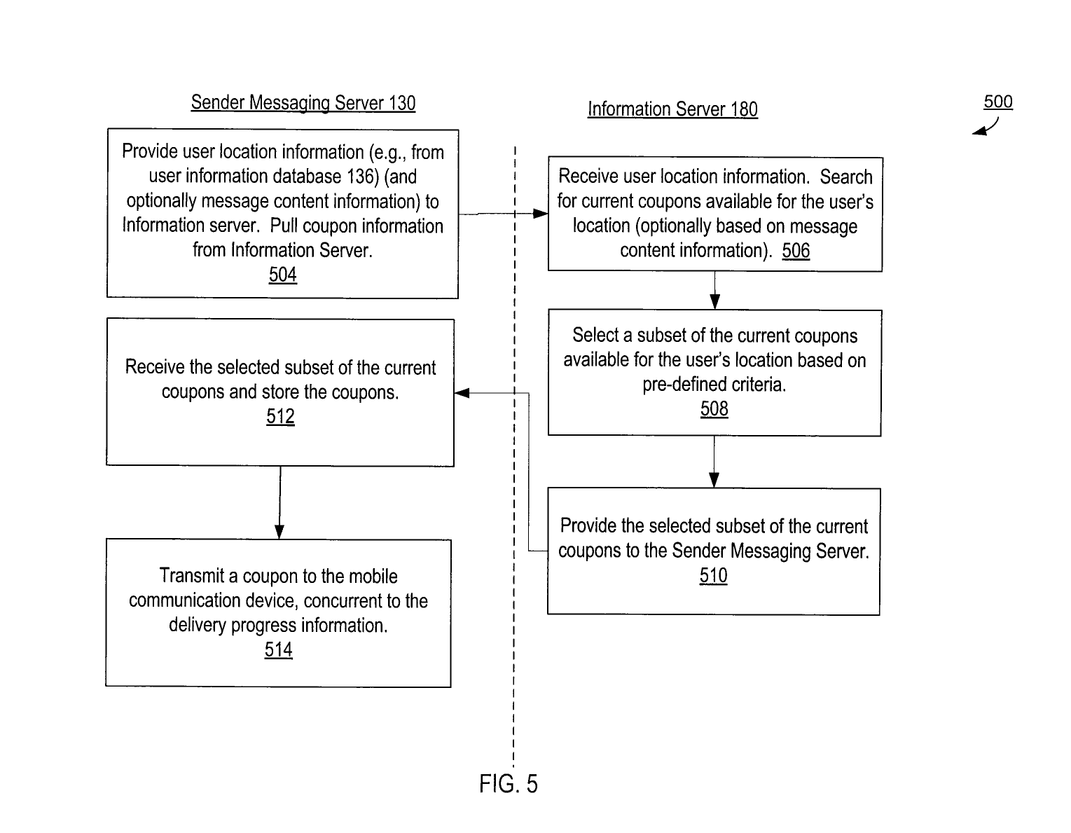

In some embodiments, sender messaging server 130 may pull the coupon from Information Server 180, in accordance with a process that is discussed further in reference to FIG. 5. In some embodiments, sender messaging server 130 pulls a coupon from Information Server 180 dynamically each time a sender 101 sends an electronic message, and an electronic message delivery process is initiated. In some embodiments, sender messaging server 130 pulls a plurality of coupons from Information Server 180 for sender 101 (for instance, the first time in a day that the sender 101 sends an electronic message), stores them in an internal cache, and serves one of these coupons each time sender 101 sends an electronic message. These coupons may be stored at any location accessible to the mobile communication device 110, for example, on a personal computer to which the mobile communication device 110 is synchronized.

At 207, sender messaging server 130 provides a waiting screen including a coupon to the electronic messaging application 399 at the mobile communication device 110. In some embodiments, sender messaging server 130 provides the waiting screen at 207 simultaneously to initiate the electronic messaging delivery process. In some embodiments, sender messaging server 130 provides the waiting screen at 207 after (e.g., immediately after) initiating the electronic message delivery process. At 209, electronic messaging application 399 at mobile communication device 110 receives the waiting screen and displays the waiting screen.

An example of a waiting screen 318 provided by the sender messaging server 130 includes a coupon and electronic message delivery progress information is illustrated by GUI 302 in FIG. 3B. Waiting screen 318 includes electronic message delivery progress information 325, which may include text and/or graphics indicating that the electronic message is being delivered. GUI 302 also includes a coupon 320. Thus, as illustrated by GUI 302, sender messaging server 130 causes display of a delivery progress message 325 that the delivery of the electronic message is in progress, and causes display of a coupon 320 simultaneous to the display of the delivery progress message 325.

Back at the sender messaging server 130, electronic message delivery continues. At 208, using the IP address of the recipient messaging server 140 from the DNS server, sender messaging server 130 connects with the recipient messaging server 140, and gives the electronic message to the recipient messaging server 140. Recipient messaging server 140 may be an SMTP, SMS/MMS, Instant Messaging, or other electronic messaging server. Sender messaging server 130 stays online with the recipient messaging server 140 until the recipient messaging server 140 provides an acknowledgment that the electronic message has been delivered to and/or stored for the recipient 155. At 210, recipient messaging server 140 delivers and/or stores the electronic message for the recipient 155, and at 212, recipient messaging server 140 provides an acknowledgement that the electronic message has been delivered to and/or stored for the recipient.

The sender messaging server 130 waits for the acknowledgment from the recipient messaging server 140 that the electronic message has been stored for the recipient 155, until a pre-defined time period expires, at 213. If the time period expires prior to receiving the acknowledgment (an “ack”) from the recipient messaging server 140 that the electronic message has been stored for the recipient 155, the sender messaging server 130 provides an error message to the electronic messaging application 399 at mobile communication device 110, at 214, which may be displayed at the MCD 101 at 215. Alternatively, or in addition, if the reception “ack” is not received within a certain time period, sender messaging server 130 may restart the delivery process.

Otherwise, at 216, if the acknowledgment from the recipient messaging server 140 that the electronic message has been stored for the recipient 155 is received prior to the expiration of the time period, then at 220, the sender messaging server 130 provides a message delivery screen, which is displayed at mobile communication device 110 at 222. Upon display of the message delivery screen, the previously displayed waiting screen with the coupon insert is no longer displayed. In some embodiments, sender messaging server 130 provides the message delivery screen at 220, only if a minimum amount of time has expired since the presentation of the coupon 320 (at time t₁). This time check may ensure that the coupon 320 was displayed for a time that is at least adequate for the sender 101 to view or read the coupon 320.

An example of a message delivery screen 328 is illustrated by GUI 303 in FIG. 3C. Message delivery screen 328 includes a delivery confirmation message and/or graphic 330 that indicates to sender 101 that the electronic message has been received at the recipient messaging server 140. Message delivery screen 328 includes a coupon activation message (and/or graphic) 332 that invites a sender 101 to save and/or activate the coupon 320. In some embodiments, the coupon activation message (and/or graphic) 332 indicates an action that must be performed by the sender 101 to activate the coupon 320. For instance, in the example illustrated in FIG. 3, coupon activation message 332 indicates that the user must select the coupon activation message 332 to save and/or activate the coupon 320. In some embodiments, it is not necessary to activate the coupon 320.

Also shown in FIG. 2A, at 218, is a second timer which may optionally be used to ensure that the coupon insert has been viewed by the sender 101 for a predetermined amount of time, thus improving the likelihood that sender 101 will activate the coupon.

In the embodiment illustrated in FIG. 2A, a sender messaging server 130 and a recipient messaging server 140 are involved. In other embodiments, one or both of the sender messaging server 130 and recipient messaging server 140 may not be involved. In one embodiment, as shown using dashed line 112 in FIG. 1, the mobile communication device and receiving client 150 can be in direct communication (e.g., peer-to-peer communication) with each other, using appropriate protocols (e.g., XMPP/Jabber). In this embodiment, the mobile communication device 110 may be served one or more coupons while sending an electronic message to the receiving client 150. These one or more coupons may be stored in local storage (e.g, in a cache or a memory) on the mobile communication device 110, and may be served from the local storage.

In another embodiment, FIG. 2B illustrates a flowchart of a method 201 for providing coupons to a receiving client 150. Method 201 is similar to method 200, except method 201 does not require the use of a recipient messaging server 140. Method 201 may be used, for instance, when the electronic message being sent by mobile communication device 110 is an SMS/MMS. In this case, sender messaging server 130 can be a Short Message Service Center (SMSC), which may provide a store-and-forward mechanism.

At 206a, sender messaging server 130 obtains an IP address of the receiving client 150. In one example, sender messaging server 130 obtains addressing information of receiving client 150 from a stored list of addressing information. At 208a, sender messaging server 130 connects with the receiving client 150, and gives the electronic message to the receiving client 150. Sender messaging server 130 waits for an acknowledgment that the electronic message has been delivered to and/or stored for the receiving client 150. At 210a, recipient client 150 receives the electronic message, and at 212a, recipient client 150 provides an acknowledgement that the electronic message has been received. At 216a, sender messaging server 130 receives the acknowledgment.

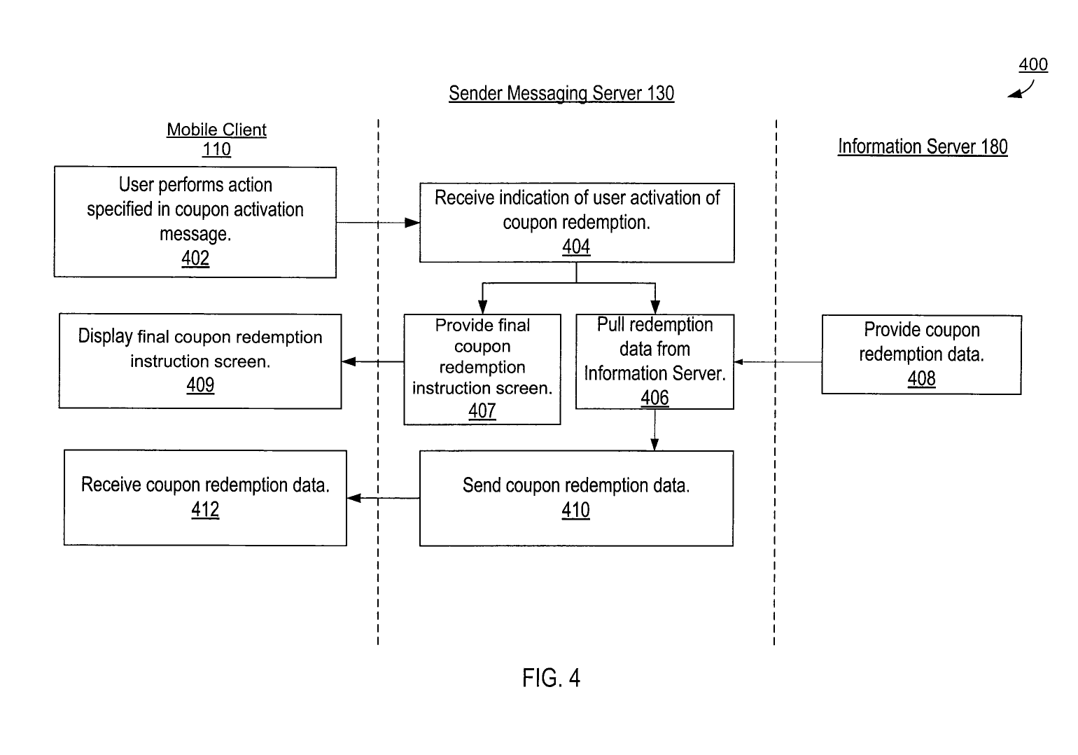

FIG. 4 illustrates a flowchart of a coupon activation process 400. At 402, sender 101 (or another user of mobile communication device 110) performs the action specified by coupon activation message 332. For instance, the coupon activation message 332 may indicate that the user must click the coupon activation message 332 to activate the coupon 320. When a user performs the action specified by coupon activation message 332 at 402 (e.g., sender 101 (or another user of mobile communication device 110) clicks the coupon activation message 332), then at 404, sender messaging server 130 receives information indicating that the user wishes to activate the coupon 320. At 406, in response to receiving the information indicating that the user wishes to activate the coupon 320, sender messaging server 130 obtains coupon redemption data. In some embodiments, coupon redemption data may be pulled from Information Server 180, which provides the coupon redemption data at 408. In some embodiments, coupon activation data may be pulled from a cache that may be local to the sender messaging server 130. In some embodiments, coupon activation data may be received along with the coupon information, for instance at 205.

At 410, sender messaging server 130 sends coupon redemption data to mobile communication device 110. In some embodiments, coupon redemption data, such as a coupon redemption code, can be sent to the mobile communication device 110, for instance, via an SMS text message or through email or provided at an Internet website. At 412, mobile communication device 110 receives the coupon redemption data. The coupon redemption data can be used by sender 101 to redeem the coupon.

FIG. 3D illustrates a GUI 304, which illustrates an example of a coupon redemption instruction screen 340. Coupon activation redemption screen 340 includes an instruction message 350, which in the example illustrated in FIG. 3, instructs sender 101 to check an Internet website or a text messaging application at mobile communication device 110 to find a text message (or email or MMS) that contains a coupon redemption code. The coupon redemption code can be used by sender 101 to activate the coupon. In some embodiments, coupon redemption data includes a bar code, which can be scanned at or by a respective merchant (e.g., at PQR Grill). Further, in some embodiments, no explicit user action is required to activate the coupon. Instead, the user can save and/or otherwise view or use the coupon without any need for activation. This may be accomplished using a “save” button or setting on GUI 303 by automatically saving all coupons for later viewing, use and/or activation.

FIG. 5 illustrates a flowchart of a process 500 for dynamically pulling a location-specific coupon for display at mobile communication device 110. At 504, sender messaging server 130 pulls coupon information from Information Server 180. In some embodiments, at 504, sender messaging server 130 also provides location information for mobile communication device 110 to Information Server 180. For instance, in some embodiments, sender messaging server 130 may provide a telephone area code associated with mobile communication device 110. Additionally or in the alternative, sender messaging server 130 may retrieve location information associated with the sender's messaging address from user information database 136. The location information associated with the sender's messaging address may be stored in the user database 136 from a time when the user registered the electronic message account, or from later updates by the user to the electronic message account. In addition, the location information associated with the sender's electronic messaging address may be obtained by analyzing the coupons that are activated by sender 101, e.g., at 402, and determining the physical area to which the coupons correspond. For instance, a user who consistently activates coupons to restaurants within the city of Palo Alto, but does not activate coupons to restaurants within the city of Mountain View, may have the city of Palo Alto stored in the user database 136. Location information may also be obtained from location aware devices as discussed above.

At 506, Information Server 180 receives a request for coupon information from sender messaging server 130. The Information Server 180 may also receive location information, either from sender messaging server 130, or by accessing the user database 136. In some embodiments, Information Server 180 may also receive other information that may be used to refine coupon search results. For instance, Information Server 180 may receive message content information from Sender Messaging Server 130. Sender Messaging Server 130 may, in turn, extract message content information, such as keywords, from the text (e.g., subject and/or body) of the electronic message.

At 506, Information Server 180 searches coupon repository 182 for current coupons available for the sender's location, and optionally based on message content information (e.g., “lunch”) received from Sender Messaging Server 130. For instance, Information Server 180 may search coupon repository 182 for current coupons available for the city of Palo Alto relating to restaurants.

At 508, Information Server 180 may select a subset of the current coupons available for the user's location based on pre-defined criteria. The pre-defined criteria may include one or more of: message content information, user preferences (e.g., the user tends to activate coupons for restaurants, but not for car oil change, or the user has otherwise indicated a preference for coupons for restaurants), amount of consideration paid by business owner (e.g., one business owner may be offering bonus for displaying their coupon), and so on.

At 510, the Information Server 180 provides the subset of the current coupons to the Sender messaging server 130. At 512, sender messaging server 130 receives the subset of the current coupons from the Information Server 180, and may optionally store the coupons (if more than one), for instance in an internal cache. In some embodiments, the coupons are cached for later display.

At 514, sender messaging server 130 transmits at least one of the coupons to mobile communication device 110 concurrent to electronic message delivery progress information. In some embodiments, optionally, the next time Sender 101 sends an electronic message, sender messaging server 130 serves at least one of the previously pulled coupons (if still current) to mobile communication device 110 concurrent to electronic message delivery progress information.

In the embodiments disclosed in FIG. 5, the Information Server 180 determines which coupon(s) to serve. In some embodiments, the mobile communication device 110 selects a coupon for display from a plurality of coupons served by Information Server 180. The selection may be based on such criteria as user preferences or message content.

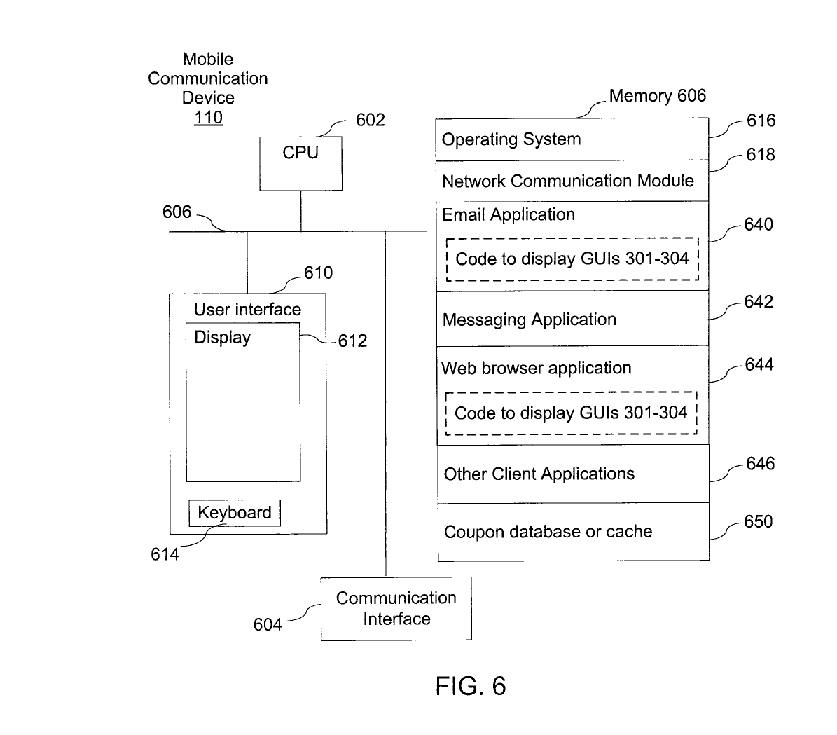

FIG. 6 is a block diagram illustrating a mobile communication device 110 in accordance with some embodiments. The mobile communication device 110 typically includes one or more processing units (CPU's) 602, one or more network or other communications interfaces 604, memory 606, and one or more communication buses 606 for interconnecting these components. The mobile communication device 110 includes a user interface 610 comprising a display device 612 and a keyboard 614. Memory 606 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory 606, or alternately the non-volatile memory device(s) within memory 606, comprises a computer readable storage medium. In some embodiments, memory 606 stores the following programs, modules and data structures, or a subset thereof:
an operating system 616 that includes procedures for handling various basic system services and for performing hardware dependent tasks;
a network communication module 618 that is used for connecting the mobile communication device 110 to other computers via the one or more communication network interfaces 604 (e.g., wireless) and one or more communication networks, such as the cellular network 115 and/or communications network 170;
an email application 640 that is used by sender 101 to send and receive emails, and optionally includes code to display GUIs 301-301;
a messaging application 642 that is used by sender 101 to send and receive messages, such as text messages, and to receive a message with coupon activation data;
an Internet or WWW browser application 644 that optionally executes code to display GUIs 301-301;
other optional client applications 646; and
a coupon database or cache 650.

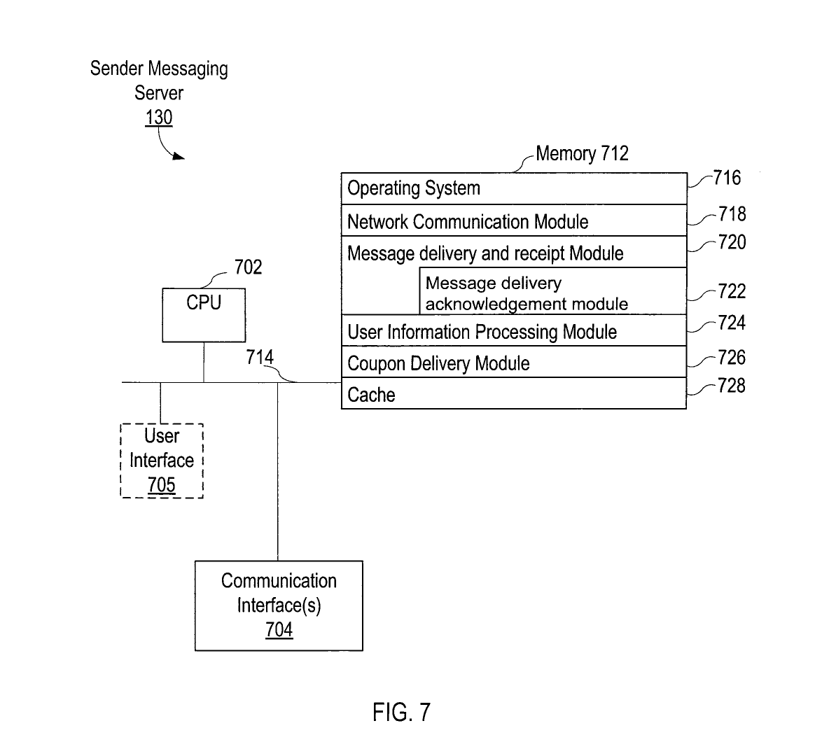

FIG. 7 is a block diagram illustrating a sender messaging server 130 in accordance with some embodiments. The sender messaging server 130 typically includes one or more processing units (CPU's) 702, one or more network or other communications interfaces 704, memory 712, and one or more communication buses 714 for interconnecting these components. The sender messaging server 130 optionally may include a user interface 705, for instance comprising a display device and a keyboard. Memory 712 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 712 may optionally include one or more storage devices remotely located from the CPU(s) 702. Memory 712, or alternately the non-volatile memory device(s) within memory 712, comprises a computer readable storage medium. In some embodiments, memory 712 stores the following programs, modules and data structures, or a subset thereof:
an operating system 716 that includes procedures for handling various basic system services and for performing hardware dependent tasks;
a network communication module 718 that is used for connecting the sender messaging server 130 to other computers via the one or more communication network interfaces 704 (wired or wireless) and one or more communication networks, such as the Internet, other wide area networks, local area networks, metropolitan area networks, and so on;
an electronic message delivery and receipt module 720 that receives electronic messages from senders (such as sender 101) and delivers the electronic messages to recipient messaging servers (e.g., recipient messaging server 140). Electronic message delivery and receipt module 720 also receives electronic messages from other electronic message servers. Electronic message delivery and receipt module 720 includes an electronic message delivery acknowledgement module 722 that provides acknowledgement of reception of an electronic message from a recipient messaging server;
a user information processing module 724 that determines user location information, e.g., from the telephone area code of mobile communication device 110, or from analyzing activated coupon information. User information processing module 724 may also determine user preferences related to coupons;
a coupon delivery module 726 that delivers a coupon to mobile communication device 110 concurrently to a waiting screen displayed by electronic message delivery acknowledgement module 722 indicating that an electronic message is being delivered. Coupon delivery module 726 pulls coupon information from Information Server 180, and may optionally store coupon information in cache 728; and
a cache 728 that stores user information obtained by user information processing module 724 and optionally stores coupon information retrieved by coupon delivery module 726 from Information Server 180. Cache 728 may also optionally store at least a subset of coupons provided to a particular mobile communication device 110.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 712 (and memory 606) may store a subset of the modules and data structures identified above. Furthermore, memory 712 (and memory 606) may store additional modules and data structures not described above.

Although FIGS. 6 and 7 show a mobile communication device 110 and sender messaging server 130 respectively, FIGS. 6 and 7 are intended more as functional description of the various features which may be present in a set of servers than as a structural schematic of the embodiments described herein. In practice, and as recognized by those of ordinary skill in the art, items shown separately could be combined and some items could be separated. For example, some items shown separately in FIG. 7 could be implemented on single servers and single items could be implemented by one or more servers. The actual number of servers used to implement a sender messaging server 130 and how features are allocated among them will vary from one implementation to another, and may depend in part on the amount of data traffic that the system must handle during peak usage periods as well as during average usage periods.

Each of the methods described herein may be governed by instructions that are stored in a computer readable storage medium and that are executed by one or more processors of one or more servers or clients. Each of the operations shown in FIGS. 2 and 3-5 may correspond to instructions stored in a computer memory or computer readable storage medium. For instance, any of methods 200, 400 and 500 may be governed by instructions that are stored in a computer readable storage medium and that are executed by one or more processors of one or more servers. The computer readable storage medium may include a magnetic or optical disk storage device, solid state storage devices such as flash memory, or other non-volatile memory device or devices. The computer readable instructions stored on the computer readable storage medium are in source code, assembly language code, object code, or other instruction format that is interpreted by one or more processors.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method, comprising: at a server,
receiving an electronic message from a mobile communication device;
forwarding the electronic message to a recipient server associated with a recipient of the electronic message;
causing display of a delivery progress message at the mobile communication device;
causing display of a coupon simultaneous to the display of the delivery progress message at the mobile communication device;
receiving an acknowledgement from the recipient server that the electronic message has been stored for the recipient; and
in response to receiving the acknowledgement, causing display of a delivery completion message at the mobile communication device.

2. The method of claim 1, wherein the electronic message is an email message.

3. The method of claim 1, further comprising retrieving the coupon from a networked coupon server.

4. The method of claim 1, further comprising determining location information for the mobile communication device, and retrieving the coupon from a networked coupon server, wherein the coupon is specific to the retrieved location information.

5. The method of claim 3, further comprising determining the location information for the mobile communication device based on a cell phone number associated with the mobile communication device, wherein the mobile communication device is a cell phone.

6. The method of claim 3, further comprising determining the location information for the mobile communication device based on location information provided by a user of the mobile communication device during a registration process.

7. The method of claim 1, further comprising causing display of the message at the mobile communication device that the electronic message has been delivered only if a predefined time period has passed since the display of the coupon.

8. The method of claim 1, further comprising:
causing display of a coupon activation message simultaneous to the display of the delivery completion message at the mobile communication device.

9. The method of claim 7, further comprising:
receiving selection information corresponding to a user selection of the coupon activation message; and
in response to receiving the selection information, sending coupon redemption data to the mobile communication device.

10. The method of claim 1, further comprising:
causing display of the coupon and the delivery progress message simultaneously in a waiting screen in an application used to send the electronic message at the first communication device.

11. The method of claim 7, further comprising:
causing display of the coupon activation message and the delivery completion message simultaneously in a screen in an application used to send the electronic message at the mobile communication device.

12. A computer-implemented method, comprising: at a mobile communication device,
sending an electronic message;
displaying a delivery progress message;
at least for the duration that the delivery progress message is displayed, displaying a coupon; and
displaying a delivery completion message.

13. The method of claim 11, wherein the coupon is specific to a location associated with the mobile communication device.

14. The method of claim 11, further comprising:
displaying a coupon activation message simultaneous to the display of the delivery completion message.

15. The method of claim 13, further comprising:
sending selection information corresponding to a user selection of the coupon activation message; and
receiving coupon redemption information.

16. The method of claim 11, further comprising:
displaying the coupon and the delivery progress message simultaneously in a waiting screen in an application used to send the electronic message at the mobile communication device.

17. The method of claim 13, further comprising:
displaying the coupon activation message and the delivery completion message simultaneously in a screen in an application used to send the electronic message at the mobile communication device.

18. A graphical user interface on a mobile communication device, comprising:
coupon information; and
a delivery progress message that delivery of an electronic message is in progress.
